(19) United States
(12) Patent Application Publication
(10) Pub. No.: US 2007/0134800 A1
(43) Pub. Date: Jun. 14, 2007

(54) Method of monitoring a predetermined type of molecule conveyed through a gaseous medium

(75) Inventors: Wu Wenzhi, Kogarah (AU); Donald Barnett, Hornsby Heights (AU); Graham Bell, Hunters Hill (AU); Brian Crowley, Balmain (AU); Brynn Hibbert, Randwick (AU); David Charles Levy, Bellevue Hill (AU); Arvind Kumar Srivastava, Des Plaines, IL (US)

Correspondence Address: WEINGARTEN, SCHURGIN, GAGNEBIN & LEBOVICI LLP, TEN POST OFFICE SQUARE, BOSTON, MA, 02109, US

(73) Assignee: E-NOSE PTY LTD

(21) Appl. No.: 11/585,350

(22) Filed: Oct. 23, 2006

Related U.S. Application Data
(63) Continuation of application No. PCT/AU05/00564, filed on Apr. 21, 2005.

(30) Foreign Application Priority Data
Apr. 21, 2004 (AU) 2004 902131

(51) Int. Cl. G06F 19/00; G01N 35/00

(52) U.S. Cl. 436/43; 702/22

(57) ABSTRACT

The present invention provides a method of monitoring a predetermined type of molecule conveyed through a gaseous medium. The method comprises that step of positioning at least one electronic detector for detecting the predetermined type of molecule. The method also comprises the steps of measuring molecules of the predetermined type to detect a quantity of the molecules and producing electronic data associated with the quantity of molecules. The method further comprises the step of monitoring changes in the electronic data so as to provide information that can be used to control a source of the predetermined type of molecule.

This application is a continuation of PCT/AU2005/000564 filed Apr. 21, 2005, and claims priority to Australian application No. 2004 902131 filed Apr. 21, 2004, which are incorporated herein by reference.

### FIELD OF THE INVENTION

The present invention broadly relates to a method of monitoring a predetermined type of molecule conveyed through a gaseous medium and relates particularly, though not exclusively, to a method of monitoring an airborne odour.

### BACKGROUND OF THE INVENTION

The pollution of air or water is an environmental problem that is of growing concern. This is true not only for pollution that results from heavy industry and machines such as automobiles, but also for pollution that is directly associated with animals or humans. For example, meat producing and livestock processing plants are often relatively large operations which emit odors that are unpleasant for the community living in the proximity of such plants. Rubbish processing plants or sewage plants are examples of sources for strong odors that relate to human waste.

In many countries the allowable emission of such odors is now regulated. However, it is often difficult or impossible to satisfactorily monitor the molecular emission of such sources and technically advanced solutions are required.

### SUMMARY OF THE INVENTION

The present invention provides in a first aspect a method of monitoring a predetermined type of molecule conveyed through a gaseous medium, comprising the steps of:

positioning at least one electronic detector for detecting the predetermined type of molecule, the predetermined type of molecule having a source,

measuring molecules of the predetermined type to detect a quantity of the molecules,

producing electronic data associated with the quantity of molecules and

monitoring changes in the electronic data so as to provide information that can be used to control the source of the predetermined type of molecule.

The molecules of the predetermined type typically result in an airborne odour and typically comprise organic molecules.

The step of monitoring changes in the electronic data is not limited to the provision of information used to control the source. For example, the changes in the electronic data can simply be used to monitor the source eg. as an indication that the source is behaving as expected.

The method typically also comprises the step of processing the electronic data in a manner such that a probable future level of the predetermined type of molecule can be predicted. For example, the method may comprise processing the electronic data using an artificial neural network that is trained using previously detected data.

The method may also comprise the step of generating an alarm signal if the molecules of the predetermined type have a level that is above a threshold level or if it is predicted that the molecules of the predetermined type will have a level that is above the threshold level for example if filters need to be replaced or are insufficient and/or the source is generally operated in a manner such that more odour is produced, eg. by treating more sewage or particular types of sewage or by processing more animals. Alternatively or additionally the method may comprise the step of controlling the source if the molecules of the predetermined type have a level that is above the threshold level or if it is predicted that the molecules of the predetermined type will have a level that is above the threshold level.

For example, the step of controlling the source may include reducing the level of the predetermined type of molecule, for example, using suitable filters or other equipment that reduce the level of the predetermined type of molecule.

The step of generating the alarm signal and/or the step of controlling the source may be conducted in an automatic manner in which the provided information about the predetermined type of molecule is used in a feedback loop to control the level of the predetermined type of molecule.

The step of positioning the or each detector typically comprises positioning more than one detector. For example, the source of the molecules may be one of a plurality of sources and each detector may be positioned in the proximity of a respective source. Alternatively, more than one detector may be positioned at each source or more than one detector may be positioned between the or each source and a predetermined area such as a residential area.

The method typically comprises the step of transmitting the electronic data from the or each detector to the processor, which may be associated with a personal computer, in a wireless manner. Further, the method may comprise the step of transmitting the information from the processor to a control device or to an operator of the source. For example, the transmission of the information to the control device or to the operator may be wireless.

The step of method may be conducted so that the information is provided substantially in real time. The or each detector typically comprises chemical sensors that allow detection of the predetermined type of molecule substantially in real time. The step of monitoring typically is conducted substantially in real time and the information typically is transmitted substantially in real time. The predetermined type of molecule typically are monitored in time intervals, such as every 30 seconds.

The or each detector typically is a multi-channel detector that may comprise an array of chemical sensors. The step of measuring typically is conducted so that more than one channel of the or each multi-channel detector are operated in parallel. Further, the or each detector may be arranged to detect temperature and humidity. The or each detector may also be arranged to detect toxic molecules and may be arranged to detect non-odorous molecules. Further, the or each detector may be arranged to distinguish or discriminate between different types of molecules and/or mixtures of molecules.

The predetermined type of molecule typically includes a mixture of molecular components. The source may also be a plurality of sources and each source may be the source for one or more molecular components.

For example, the gaseous medium may be air and the predetermined type of molecule may be associated with human or animal related organic waste that result in an odour. Particular examples include waste from sewage plants, rubbish processing plants and meat and livestock processing plants.

For example, a particular odour may be characteristic for a source. The step of detecting the predetermined type of molecule may then comprise identifying the source of the predetermined type of molecule. For example, if the detected predetermined type does not relate to a “fingerprint” that corresponds to the characteristic odour, an operator of the source, such as a meat processing plant, can then prove that the detected predetermined type of molecule is not associated with the operator's source.

The present invention provides in a second aspect a system for monitoring a predetermined type of molecule conveyed through a gaseous medium, the system comprising:

at least one electronic detector for detecting the predetermined type of molecule, the or each detector being arranged for measuring the molecules of the predetermined type to detect a quantity of the molecules and to produce electronic data associated with the quantity of the molecules and

a processor for analysing the electronic data to provide information that can be used to control a source of the predetermined type of molecule.

The molecules of the predetermined type typically result in an airborne odour and typically comprise organic molecules.

The processor typically is arranged to predict probable future data and may comprise an artificial neural network which can be trained to predict the probable future data.

The processor may be arranged to generate an alarm signal if the molecules of the predetermined type have a level that is above a threshold level or if it is predicted that the molecules of the predetermined type will have a level that is above the threshold level. For example, the system may comprise a control device for controlling the source if the molecules of the predetermined type have a level that is above the threshold level or if it is predicted that the molecules of the predetermined type will have a level that is above the threshold level.

The control device may be arranged to automatically reduce the level of the predetermined type of molecule, for example using suitable filters or other suitable equipment, if the molecules of the predetermined type have a level that is above the threshold level or if it is predicted that the molecules will have a level that will be above the threshold level.

The system may be automated so that in use the processor provides information about the predetermined type of molecule and the information is fed back in a feedback loop to the control device or to an operator of the source.

The system typically comprises at least one transmitter for transmitting the electronic data from the or each detector to the processor. The or each transmitter may be a wireless transmitter. Alternatively, the system may be arranged for transmission of the data via electric lines such as telecommunication lines and the transmission of the data may also involve the Internet. Further, the detector and processor may also be in close proximity to each other, such as in one housing, and may be directly electronically connected.

The processor may be linked to a wireless transmitter for transmitting the information to an operator of the source in a wireless manner. The system may alternatively be arranged for transmission of the information via electric lines such as telecommunication lines and transmission of the data may also involve the Internet. The system may also comprise an automatic control device to which the information is transmitted and which may control the source. For example, the system may comprise a receiver to receive the information and the receiver may be associated with an operator of the plant or with the automatic control device.

The or each detector may comprise more than one channel and typically is an array of chemical sensors. The or each detector may also be arranged to detect temperature and humidity. In one specific example the or each detector comprises an array of five chemical sensors and temperature and humidity sensors. Further, the or each detector may be arranged to detect toxic molecules and may also be arranged to distinguish between different types of predetermined molecules.

The system typically comprises more than one detector. Each detector typically is arranged for positioning in the proximity of at least one source of the predetermined molecules. Alternatively or additionally, more than one detector may be positioned between the or each source and a predetermined area such as a residential area. Typically the detectors and the processor are arranged so that more than one detector can be linked to the processor. For example, the detectors and the processor may be arranged for linkage in a wireless manner.

The predetermined type of molecule typically includes a mixture of different molecular components. The source may also be a plurality of sources. For example the gaseous medium may be air and the predetermined type of molecule may be associated with human or animal related organic waste that give rise to an odour. Particular examples include waste from sewage plants, rubbish processing plants and meat and livestock processing plants.

The processor typically is associated with a computer and may be positioned in the proximity of the detector.

The present invention provides in a third aspect a method of analysing data from a detector for detecting a predetermined type of molecule conveyed through the gaseous medium, the method comprising:

selecting at least one data class which is associated with previously detected data,

receiving new data from the detector,

comparing the new data with the or each selected class and

identifying if the new data is associated with the or each selected class.

The molecules of the predetermined type typically result in an airborne odour and typically comprise organic molecules.

The inventors have observed that often an airborne odour, such as odour from a livestock processing plant, re-occurs in cycles. Therefore, it is advantageous to classify the airborne odour in classes which may each correspond to a cycle. In this way it is possible to then detect whether new data is typical for a selected or given class or deviates from that class. This may then indicate that a deviation from normal or expected behaviour has occurred.

The step of comparing the new data typically includes processing the data using a computer software supported data clustering technique such as a k-means clustering technique. The step of identifying the data typically also includes a discrimination analysis which is used to associate the new data from the detector with the or each selected class.

The present invention provides in a fourth aspect a method of analysing data from a detector for detecting a predetermined type of molecule conveyed through a gaseous medium, the method comprising:

receiving sequences of first data from the detector,

training an artificial neural network using the sequences of the first data so that the trained artificial neural network can be used to predict probable future data that is sequential to received second data,

receiving the second data from the detector and

processing the second data using the trained artificial neural network to predict the probable future data.

The molecules of the predetermined type typically result in an airborne odour and typically comprise organic molecules.

As the method of the fourth aspect can be used to predict data, it is possible to warn that unwanted events may happen. The method typically comprises the step of generating an alarm signal if it is predicted that the molecules of the predetermined type will have a level that will be above a threshold value.

In one specific embodiment the method of the fourth aspect also comprises the steps of:

selecting at least one data class which is associated with previously detected data,

comparing the probable predicted future data with the or each selected class and

identifying if the probable predicted future data is associated with the or each selected class.

The invention will be more fully understood from the following description of specific embodiments of the invention. The description is provided with reference to the accompanying drawings.

### BRIEF DESCRIPTION OF THE DRAWINGS

FIG. 1 shows a schematic representation of a system for monitoring a predetermined type of molecule conveyed through a gaseous medium according to a specific embodiment of the invention,

FIG. 2 shows a voltage versus time plot of data from a detector according to another specific embodiment of the invention,

FIG. 3 shows a plot visualizing cluster of data detected using a method according to an embodiment of the invention,

FIG. 4 shows a flow-chart for a further method embodiment of the invention and

FIG. 5 illustrates the operation of an artificial neural network according to an embodiment of the invention.

### DETAILED DESCRIPTION OF SPECIFIC EMBODIMENTS

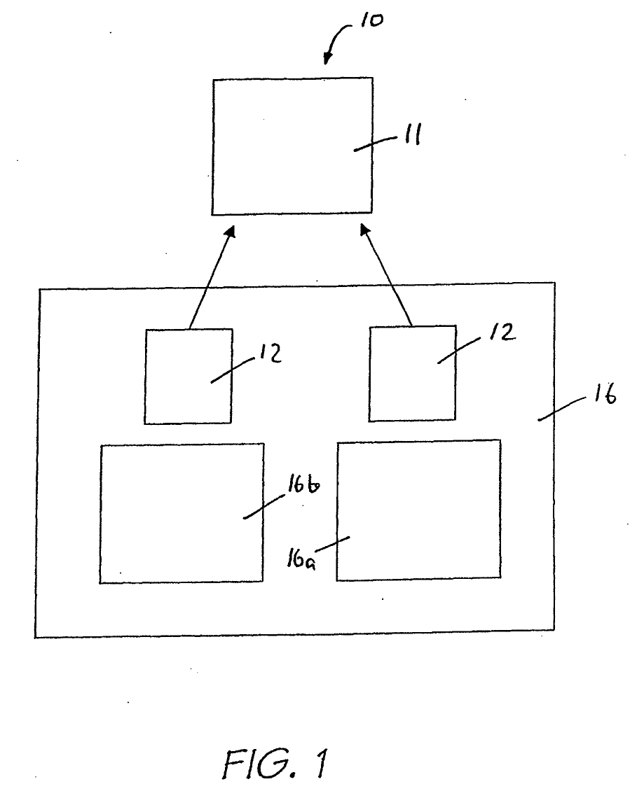

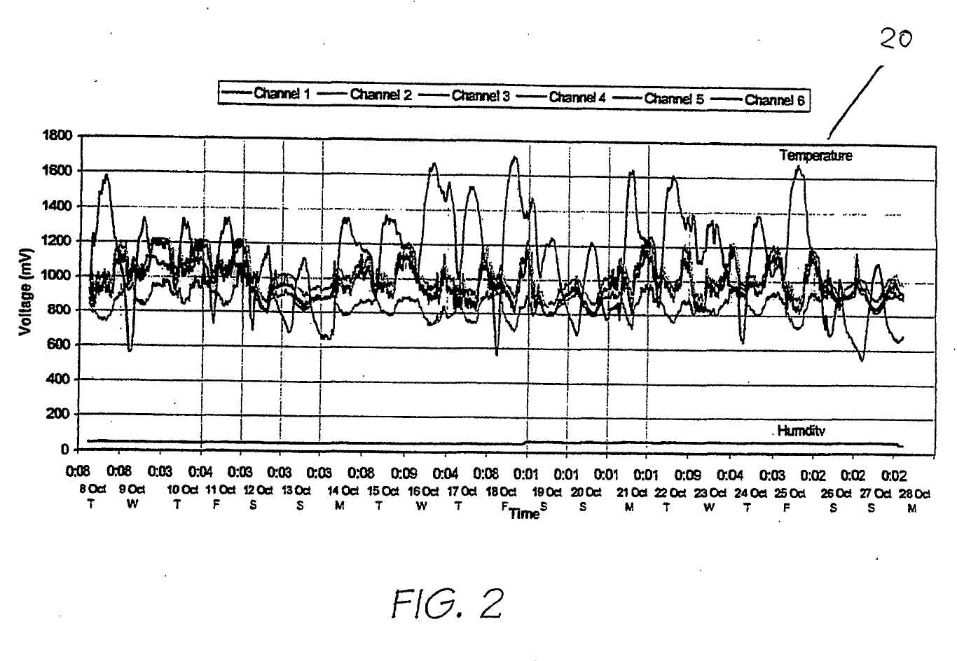

Referring initially to FIGS. 1 and 2, a method of monitoring a predetermined type of molecule conveyed through the gaseous medium and a system for monitoring the predetermined type of molecule conveyed through the gaseous medium is now described. In this embodiment the molecules of the predetermined type typically result in an airborne odour.

FIG. 1 shows a schematic representation of the system 10. The system 10 comprises three detectors 12 and a processor 14. The detectors 12 are positioned in the proximity of odour sources 16 (a) and 16 (b) of a plant 16.

The plant 16 may be a sewage plant, a meat producing or livestock processing plant. The detectors 12 are in this embodiment multi channel array detectors that comprise an array of five chemical sensors. Each sensor is in this embodiment an odour sensor that has a surface which comprises receptor for the predetermined type of molecule. When a particular type of odour molecule interacts with a receptor molecule, an electrical property of the sensor surface changes and therefore the odour molecule can be detected. Such multi channel array detectors are also known as “e-nose”. Each detector also has a separate detector channel for detecting a temperature and a separate detection channel for detecting humidity.

For example, the detectors 12 may comprise surface acoustic wave sensors, conducting polymer sensors, quartz crystal microbalance sensors, fibre optic sensors, metal oxide sensors. In this embodiment, the detector 12 comprises five tin-oxide sensors.

In this embodiment the detectors 12 also comprise a concentrator that is arranged to concentrate the odour prior to detection of the odour by the sensors of the detectors 12.

The detectors 12 are arranged to produce electronic data that is associated with the airborne odour. In this embodiment the detectors 12, positioned in the proximity of odour sources 16 (a) and (b), are exposed to the airborne odour from the plant 16. The detectors 12 then produce electronic data that is associated with a quantity of the airborne odour. The electronic data is directed to processor 14 which is, in this embodiment, positioned remote from the detectors 12. In this embodiment, the detectors 12 are arranged for wireless transmission of the data to the processor 14. For example, the wireless transmission may involve transmission via a satellite.

The detectors 12 may be arranged so that they can be operated independent form an electricity source. For example, the detectors 12 may comprise solar cells for the generation of electricity.

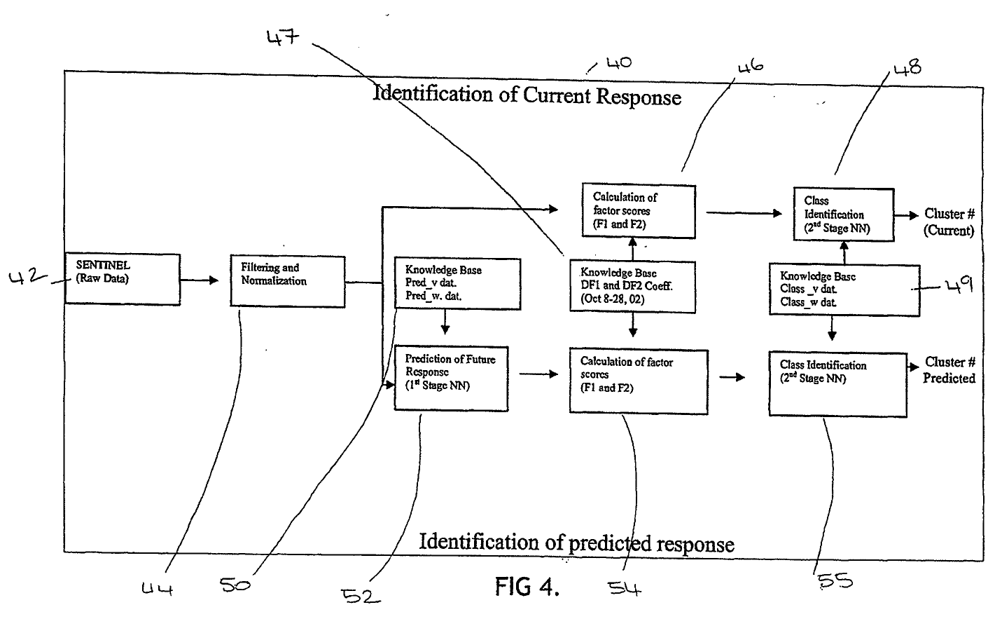

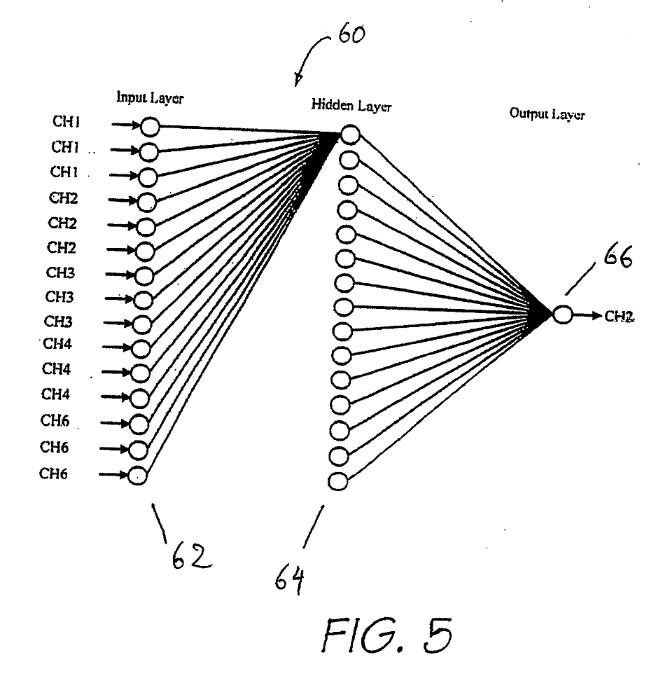

The processor 14 processes the electronic data to provide information about the airborne odour. For example, the processor 14 may comprise an artificial neural network that is arranged to be trained to predict probable future data (the neural network is described below in the context of FIGS. 4 and 5). The processor 14 has an alarm function which is activated if the detected airborne odour is above a threshold level or if it is predicted by the artificial neural network that the airborne odour will be above the threshold level. For example, the alarm function may activate an alarm noise and/or flashing of an alarm signal at the plant 16 or at another monitoring station. The alarm function may also generate a message to an operator of the plant 16 such as an e-mail message and/or a phone call.

Information about the airborne odour is transmitted to the plant 16 in a wireless manner. For example, the wireless transmission may involve transmission via a satellite. In this embodiment the information is received by an operator of the plant 16. Therefore, if the processor 14 transmits an alarm signal, the operator at the plant 16 can take appropriate action to reduce the level of the airborne odour. In this embodiment the information from the detector 12 therefore is directed back to the plant 16 in a feedback loop.

In a variation of this embodiment the process of controlling the odour source at the plant 16 is conducted in an automated manner. In this case, the information about the odour is sent from the processor 14 to an control device at the plant 16. In response to alarm signal received from the processor 14, the control device may automatically reduce the level of the odour (for example by filtering).

In a further variation of this embodiment the processor 14 is arranged to transmit the information to a third party, such as a delegated officer which monitors the emission of airborne odors from plant 16.

FIG. 2 shows an example of electronic data provided by one of the detectors 12. The plot 20 shows the output of the five chemical sensors and the output of the temperature and humidity sensors. Typically measurements are taken in predetermined intervals such as every 0.5 seconds and then sequentially converted into electronic data and sent to the processor 14.

In this embodiment the airborne odour from plant 16 is a mixture of odour components which is characteristic for plant 16. If a detected odour does not relate to a “fingerprint” that corresponds to the odour that is characteristic for plant 16, an operator of plant 16 can then prove that the detected odour is not associated with plant 16.

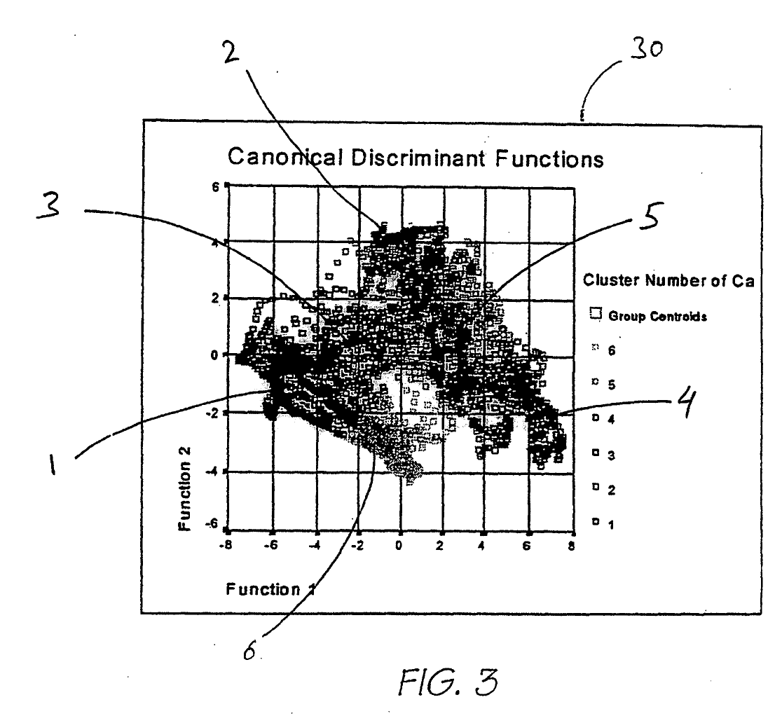

FIG. 3 shows a plot 30 that visualises six classes (classes 1 to 6) of data. Each marker in the plot 30 corresponds to a reading of one detector 12 at a particular time. To classify the data, initially in the six typical classes of data are selected. For example, previously recorded data of six different types are preselected and correspond to six individual markers in plot 30. The data from the detector 12 is then processed by processor 14 using a clustering algorithm. In this case the clustering algorithm is a K-means cluster algorithm which generates functions 1 and 2. Plot 30 displays the function 1 versus the function 2 in a 2-D plot. This algorithm is suitable to identify with which preselected class of data the data from a detector 12 may be associated. This analysis procedure also includes a discrimination analysis in which it is decided where the boundaries between the different classes of data are that define an area around each of the six individual preselected type of data in the plot 30. Therefore, the discrimination analysis determines the extension of these areas that are giving the same shading in plot 30.

Referring now to FIGS. 4 and 5, another method embodiment of the invention is now described. FIG. 4 shows a flow chart 40. The data 42 from each detector 12 is initially filtered and normalized (step 44). The data is then classified (step 46) using the above-described procedure.

In practice, many factors such as the temperature and the humidity have an impact on the data generated by each detector 12. In this embodiment an artificial neural network is used to account for these factors and to support classification of the data. The artificial neural network which forms part of the processor 14 (the artificial neural network is not shown), is trained using previously recorded data to establish knowledge base 49. The artificial neural network is then used to classify the data (step 48). The operation of the neural network will be described below.

The filtered and normalised data are, in this embodiment, also used to predict probable future data. For this purpose the artificial neural network is also trained using previously detected data to establish knowledge base 50. From previously detected data sequences, which comprise information about humidity and temperature as well as the readings of the chemical sensors, the artificial neural network has learned to predict probable future data that follow a currently detected data sequence. A k-means class analysis is then conducted on the predicted data (step 52) and the artificial neural network is used to classify the cluster data (steps 54 and 55).

FIG. 5 shows a diagram that illustrates the operation of the artificial neural network 60. As a person skilled in the art would appreciate, an artificial neural network typically comprises an input layer 62, a hidden layer 64 and an output layer 66 connected in a feed forward fashion. In this embodiment artificial neural network 60 is used that comprises 15 notes in the input layer 62 each corresponding to a reading to one channel of the multi channel detector at a particular time. In this embodiment the output layer consists of one neuron of the hidden layer 64 arranged for sigmoidal activation and is used to map input data sets to output data sets. It is to be appreciated that the neural network 60 can be used to predict the data associated with any one of the channels of each detector 12.

Even though the invention has been described with reference to particular examples it will be appreciated by those skilled in the art that the invention may be embodied in many other forms. For example, the system may comprise any number of detectors 12. Further, each detector 12 may be any type of detector which may comprise any number of sensors. Further, the processor 14 be positioned in the same housing as one of the detectors 12.

It is also to be appreciated that the present invention is not limited to airborne odors. For example, the gaseous medium may not comprise air but may comprise another gas or gaseous mixture. Further, the predetermined type of molecule may be odorless gas particles that may be toxic such as carbon monoxide.

Transmission between the detector and the processor and between processor and the operator may alternatively be conducted using electrical connections such as telecommunication lines and may also include usage of the Internet.

Further, more than one detector may be associated with one transmitter for transmitting the electronic data to the processor.

1. A method of monitoring a predetermined type of molecule conveyed through a gaseous medium, comprising the steps of:
positioning at least one electronic detector for detecting the predetermined type of molecule, the predetermined type of molecule having a source,
measuring molecules of the predetermined type to detect a quantity of the molecules,
producing electronic data associated with the quantity of molecules,
monitoring changes in the electronic data so as to provide information that can be used to control the source of the predetermined type of molecule,
processing the electronic data in a manner such that a probable future level of the predetermined type of molecule can be predicted, and
generating an alarm signal if it is predicted that the molecules of the predetermined type will have a level that is above a threshold level.

2. The method of claim 1 wherein the molecules of the predetermined type result in an airborne odour and comprise organic molecules.

3. The method of claim 1 wherein the step of processing the electronic data comprises use of an artificial neural network that is trained using previously detected data.

4. The method of claim 1 comprising the step of generating an alarm signal if the molecules of the predetermined type have a level that is above a threshold level.

5. The method of claim 1 comprising the step of controlling the source if the molecules of the predetermined type have a level that is above the threshold level.

6. The method of claim 1 comprising the step of controlling the source if it is predicted that the molecules of the predetermined type will have a level that is above the threshold level.

7. The method of claim 1 comprising the step of transmitting the electronic data from the or each detector to a processor in a wireless manner.

8. The method of claim 1 comprising the step of transmitting the information from a processor in a wireless manner.

9. The method of claim 1 conducted so that the information is provided substantially in real time.

10. The method of claim 6 wherein the step of controlling the source is conducted in an automatic manner in which the provided information about the predetermined type of molecule is used in a feedback loop to control a level of the predetermined type of molecule.

11. The method of claim 1 wherein the step of positioning the or each detector comprises positioning more than one detector.

12. The method of claim 11 wherein the source of the molecules is one of a plurality of sources and each detector is positioned in the proximity of a respective source.

13. The method of claim 11 wherein more than one detector are positioned between the source and a predetermined area.

14. A system for monitoring a predetermined type of molecule conveyed through a gaseous medium, the system comprising:
at least one electronic detector for detecting the predetermined type of molecule, the or each detector being arranged for measuring the molecules of the predetermined type to detect a quantity of the molecules and to produce electronic data associated with the quantity of the molecules and
a processor for analysing the electronic data to provide information that can be used to control a source of the predetermined type of molecule,
wherein the processor is arranged to predict probable future data and generates an alarm signal if it is predicted that the molecules of the predetermined type will have a level that is above a threshold level.

15. The system of claim 14 wherein the predetermined type of molecule conveyed through the gaseous medium is organic and results in an airborne odour.

16. The system of claim 14 wherein the processor comprises an artificial neural network which can be trained to predict the probable future data.

17. The system of claim 14 wherein the processor is arranged to generate an alarm signal if the molecules of the predetermined type have a level that is above a threshold level.

18. The system of claim 14 comprising a control device that is arranged to reduce the level of the predetermined type of molecule if the molecules of the predetermined type have a level that is above the threshold level.

19. The system of claim 14 comprising a control device that is arranged to reduce the level of the predetermined type of molecule if it is predicted that the molecules of the predetermined type will have a level that is above the threshold level.

20. The system of claim 14 comprising at least one transmitter for transmitting the electronic data from the or each detector to the processor in a wireless manner.

21. The system of 14 wherein the processor is linked to a wireless transmitter for transmitting the information to an operator of the source in a wireless manner.

22. The system of claim 14 wherein the processor is linked to a wireless transmitter for transmitting the information to the control device in a wireless manner.

23. The system of claim 14 wherein the or each detector is an array of chemical sensors.

24. The system of claim 14 comprising more than one detector and wherein each detector is arranged for linkage to the processor in a wireless manner.

25. A method of analysing data from a detector for detecting a predetermined type of molecule conveyed through a gaseous medium, the method comprising:
receiving sequences of first data from the detector,
training an artificial neural network using the sequences of the first data so that the trained artificial neural network can be used to predict probable future data that is sequential to received second data,
receiving the second data from the detector,
processing the second data using the trained artificial neural network to predict the probable future data, and
generating an alarm signal if it is predicted that the molecules of the predetermined type will have a level that will be above a threshold value.

26. The method of claim 25 wherein the predetermined type of molecule conveyed through the gaseous medium is organic and results in an airborne odour.

27. The method of claim 25 comprising the steps of:
selecting at least one data class which is associated with previously detected data,
comparing the probable predicted future data with the or each selected class and
identifying if the probable predicted future data is associated with the or each selected class.
